(19) United States
(12) Patent Application Publication
(10) Pub. No.: US 2020/0013180 A1
(43) Pub. Date: Jan. 9, 2020

(54) HEIGHT CALCULATION SYSTEM, INFORMATION PROCESSING APPARATUS, AND NON-TRANSITORY COMPUTER READABLE MEDIUM STORING PROGRAM

(71) Applicant: FUJI XEROX CO., LTD., Tokyo (JP)

(72) Inventors: Yusuke YAMAURA, Kanagawa (JP); Masatsugu TONOIKE, Kanagawa (JP); Jun SHINGU, Kanagawa (JP); Daisuke IKEDA, Kanagawa (JP); Yusuke UNO, Kanagawa (JP)

(73) Assignee: FUJI XEROX CO., LTD., Tokyo (JP)

(21) Appl. No.: 16/150,291

(22) Filed: Oct. 3, 2018

(30) Foreign Application Priority Data
Jul. 3, 2018 (JP) 2018-126737

(51) Int. Cl. G06T 7/60; G06K 9/00

(52) U.S. Cl. CPC G06T 7/60; G06K 9/00362; G06K 9/00228; G06T 2207/30242; G06T 2207/30201; G06K 2009/00322; G06T 2207/10016

(57) ABSTRACT

A height calculation system includes a capturing section that captures an image, a detection section that detects a specific body part of a human in the image captured by the capturing section, and a calculation section that calculates the height of the human based on the size of the part when the one part detected by the detection section overlaps with a specific area present in the image.

### CROSS-REFERENCE TO RELATED APPLICATIONS

This application is based on and claims priority under 35 USC 119 from Japanese Patent Application No. 2018-126737 filed Jul. 3, 2018.

### BACKGROUND

### (i) Technical Field

The present invention relates to a height calculation system, an information processing apparatus, and a non-transitory computer readable medium storing a program.

### (ii) Related Art

JP2013-037406A discloses estimation of a foot position of a target person for each assumed height from each of images captured in a time series manner by a capturing unit using a head part detected by a head part detection unit.

### SUMMARY

For example, there is a technology such that the height of a human displayed in an image is calculated from the distance between the head and a foot of the human body displayed in the captured image. However, depending on cases, both of the head and the foot of the human body may not be displayed in the captured image. In this case, the height of the person displayed in the image may not be easily calculated.

Aspects of non-limiting embodiments of the present disclosure relate to a height calculation system, an information processing apparatus, and a non-transitory computer readable medium storing a program which provide calculation of the height of a human displayed in an image based on the image in which a part of the human body is displayed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a height calculation system including a capturing section that captures an image, a detection section that detects a specific body part of a human in the image captured by the capturing section, and a calculation section that calculates a height of the human body based on a size of the part when the one part detected by the detection section overlaps with a specific area present in the image.

### BRIEF DESCRIPTION OF THE DRAWINGS

Exemplary embodiment(s) of the present invention will be described in detail based on the following figures, wherein:

FIG. 1 is a diagram illustrating an overall configuration example of a height calculation system;

FIG. 2 is a block diagram illustrating a hardware configuration of an information processing apparatus;

FIG. 3 is a diagram illustrating a functional configuration of the information processing apparatus;

FIG. 4 is a diagram illustrating one example of a hardware configuration of a terminal apparatus;

FIG. 5 is a diagram illustrating a functional configuration of the terminal apparatus;

FIG. 6A is a diagram illustrating a state where a person walks within a capturing area of a video camera disposed in a store, and FIG. 6B is a diagram illustrating one example of a motion picture that is acquired from the video camera by a motion picture data acquiring unit;

FIG. 7 is a diagram illustrating a configuration example of a face pixel count management table for managing a face pixel count in a storage unit;

FIG. 8 is a diagram illustrating one example of a histogram created by a scale creating unit;

FIG. 9 is a diagram illustrating a height scale;

FIG. 10 is a diagram illustrating a method of calculating height by a height calculation unit;

FIG. 11 is a flowchart illustrating a flow of height calculation process;

FIG. 12 is a diagram illustrating a calculation result image that is an image related to a result of calculation of height by the height calculation unit; and

FIGS. 13A and 13B are diagrams illustrating a method of correcting each pixel count that is associated with height for each attribute.

### DETAILED DESCRIPTION

Hereinafter, an exemplary embodiment of the present invention will be described in detail with reference to the accompanying drawings.

Configuration of Height Calculation System 10

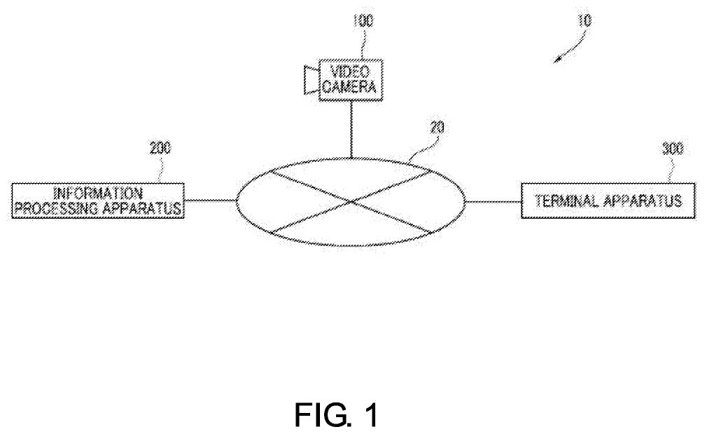

FIG. 1 is a diagram illustrating an overall configuration example of a height calculation system 10 according to the present exemplary embodiment. The height calculation system 10 of the exemplary embodiment includes a video camera 100 as one example of a capturing section, an information processing apparatus 200, and a terminal apparatus 300. Through a network 20, the video camera 100 and the information processing apparatus 200 are connected to each other, and the information processing apparatus 200 and the terminal apparatus 300 are connected to each other.

The network 20 is an information communication network for communication between the video camera 100 and the information processing apparatus 200, and between the information processing apparatus 200 and the terminal apparatus 300. The type of network 20 is not particularly limited, provided that data may be transmitted and received through the network 20. The network 20 may be, for example, the Internet, a local area network (LAN), or a wide area network (WAN). A communication line that is used for data communication may be wired or wireless. The network 20 connecting the video camera 100 and the information processing apparatus 200 to each other may be the same as or different from the network 20 connecting the information processing apparatus 200 and the terminal apparatus 300 to each other. While illustration is not particularly provided, a relay device such as a gateway or a hub for connecting to a network or a communication line may be disposed in the network 20.

The height calculation system 10 of the exemplary embodiment analyzes a motion picture in which a person is displayed, and calculates the size of the face of the person displayed in the motion picture. The height of the person having the face is calculated based on the calculated size of the face. A specific method of calculating the height will be described in detail below.

The video camera 100 captures a walking person. The video camera 100 of the exemplary embodiment is disposed in a facility such as the inside of a store or on a floor of an airport. The video camera 100 may be disposed on the outside of a facility such as a sidewalk.

The video camera 100 of the exemplary embodiment has a function of transmitting the captured motion picture as digital data to the information processing apparatus 200 through the network 20.

The information processing apparatus 200 is a server that analyzes the motion picture captured by the video camera 100 and calculates the height of the person based on the size of the face of the person displayed in the motion picture.

The information processing apparatus 200 may be configured with a single computer or may be configured with plural computers connected to the network 20. In the latter case, the function of the information processing apparatus 200 of the exemplary embodiment described below is implemented by distributed processing by the plural computers.

The terminal apparatus 300 is an information terminal that outputs information related to the height of the person calculated by the information processing apparatus 200. The terminal apparatus 300 is implemented by, for example, a computer, a tablet information terminal, a smartphone, or other information processing apparatuses.

Hardware Configuration of Information Processing Apparatus 200

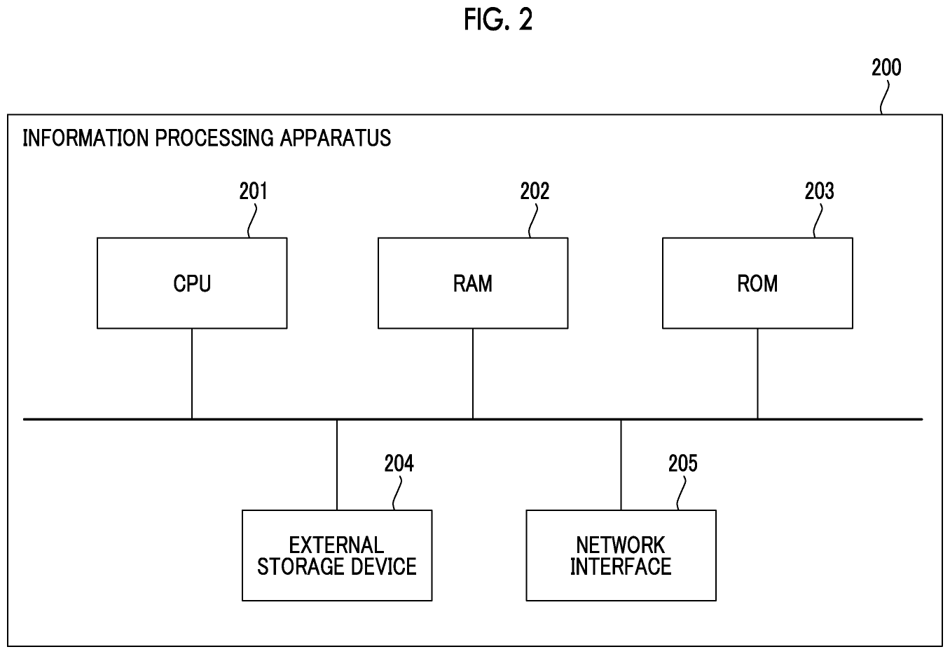

FIG. 2 is a block diagram illustrating a hardware configuration of the information processing apparatus 200.

As illustrated in FIG. 2, the information processing apparatus 200 includes a central processing unit (CPU) 201, a RAM 202, a ROM 203, an external storage device 204, and a network interface 205.

The CPU 201 performs various controls and operation processes by executing a program stored in the ROM 203.

The RAM 202 is used as a work memory in the control or the operation process of the CPU 201.

The ROM 203 stores various kinds of data used in the program or the control executed by the CPU 201.

The external storage device 204 is implemented by, for example, a magnetic disk device or anon-volatile semiconductor memory on which data may be read and written. The external storage device 204 stores the program that is loaded into the RAM 202 and executed by the CPU 201, and the result of the operation process of the CPU 201.

The network interface 205 connects to the network 20 and transmits and receives data with the video camera 100 or the terminal apparatus 300.

The configuration example illustrated in FIG. 2 is one example of a hardware configuration for implementing the information processing apparatus 200 using a computer. A specific configuration of the information processing apparatus 200 is not limited to the configuration example illustrated in FIG. 2, provided that the functions described below may be implemented.

Functional Configuration of Information Processing Apparatus 200

Next, a functional configuration of the information processing apparatus 200 will be described.

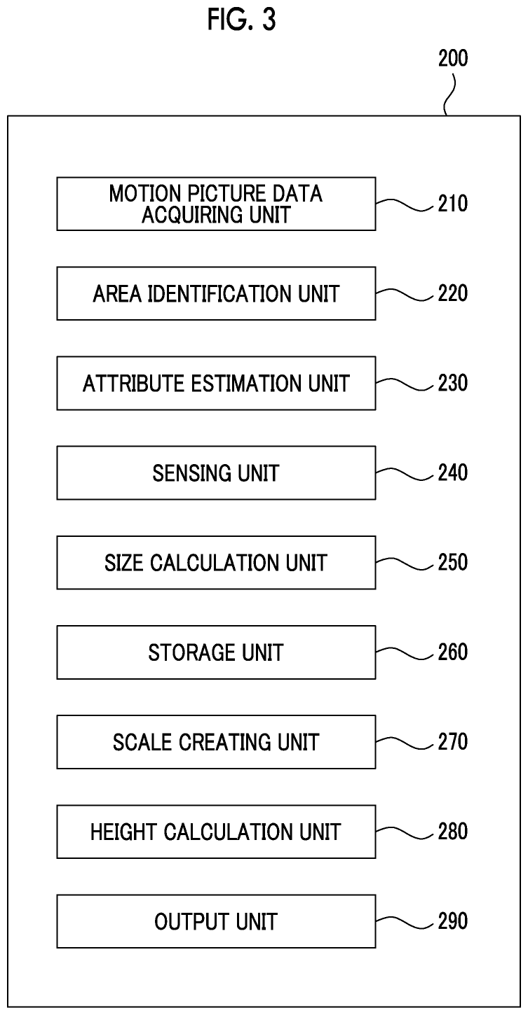

FIG. 3 is a diagram illustrating a functional configuration of the information processing apparatus 200.

As illustrated in FIG. 3, the information processing apparatus 200 includes a motion picture data acquiring unit 210, an area identification unit 220, an attribute estimation unit 230, a sensing unit 240, a size calculation unit 250, a storage unit 260, a scale creating unit 270, a height calculation unit 280, and an output unit 290.

The motion picture data acquiring unit 210 acquires motion picture data from the video camera 100 through the network 20. The acquired motion picture data is stored in, for example, the RAM 202 or the external storage device 204 illustrated in FIG. 2.

The area identification unit 220 analyzes the motion picture acquired by the motion picture data acquiring unit 210 and identifies an area in which the face of the person is displayed. Specifically, the area identification unit 220 identifies the area in which the face of the person is displayed by detecting the face of the person displayed in the motion picture based on brightness, saturation, hue, and the like in the motion picture. Hereinafter, the area in which the face of the person is displayed will be referred to as a face area. The area identification unit 220 is regarded as a detection section that detects the face of a human body displayed in an image. The face of the human body is regarded as one specific part of the human body.

The attribute estimation unit 230 as one example of an estimation section estimates the attribute of the person having the face based on the image of the face detected by the area identification unit 220. Specifically, the attribute estimation unit 230 extracts features such as parts, contours, and wrinkles on the face from the face area identified by the area identification unit 220 and estimates the attribute of the person having the face based on the extracted features. The attribute of the person is exemplified by, for example, the sex or the age group of the person.

The sensing unit 240 senses that the face area identified by the area identification unit 220 overlaps with a specific area in the motion picture. The specific area in the motion picture will be described in detail below.

The size calculation unit 250 calculates the size of the face area identified by the area identification unit 220. Specifically, the size calculation unit 250 calculates the size of the face area by calculating the number of pixels (pixel count) constituting the image of the face area when the sensing unit 240 senses that the face area overlaps with the specific area in the motion picture. Hereinafter, the pixel count constituting the image of the face area when the sensing unit 240 senses that the face area overlaps with the specific area in the motion picture will be referred to as a face pixel count. The face pixel count is regarded as part information related to the size of the face when the face detected by the area identification unit 220 overlaps with the specific area.

The storage unit 260 stores the face pixel count calculated by the size calculation unit 250 in association with the attributes estimated by the attribute estimation unit 230 for the person having the face. Accordingly, information related to the face pixel count is accumulated for each person.

The scale creating unit 270 creates a scale as a measure used in calculation of the height. Specifically, the scale creating unit 270 as one example of an acquiring section acquires information related to the face pixel count stored in the storage unit 260 and determines a pixel count to be associated with a predetermined height based on the acquired information. The scale creating unit 270 associates the pixel count with the predetermined height for each attribute estimated by the attribute estimation unit 230. That is, the scale creating unit 270 of the exemplary embodiment determines each pixel count to be associated with the height determined for each attribute. Accordingly, a height scale in which the pixel count associated with the predetermined height is illustrated for each attribute is created. A method of creating the scale will be described in detail below.

The height calculation unit 280 as one example of a calculation section calculates the height of the person displayed in the motion picture. Specifically, the height calculation unit 280 calculates the height of the person having the face detected by the area identification unit 220 using the height scale created by the scale creating unit 270. A method of calculating the height will be described in detail below.

The output unit 290 transmits information related to the height calculated by the height calculation unit 280 to the terminal apparatus 300 through the network 20.

The motion picture data acquiring unit 210, the area identification unit 220, the attribute estimation unit 230, the sensing unit 240, the size calculation unit 250, the storage unit 260, the scale creating unit 270, the height calculation unit 280, and the output unit 290 are implemented by cooperation of software and hardware resources.

Specifically, in the exemplary embodiment, an operating system and application software and the like executed in cooperation with the operating system are stored in the ROM 203 (refer to FIG. 2) or the external storage device 204. In the exemplary embodiment, each of the function units of the motion picture data acquiring unit 210, the area identification unit 220, the attribute estimation unit 230, the sensing unit 240, the size calculation unit 250, the scale creating unit 270, the height calculation unit 280, and the output unit 290 is implemented by causing the CPU 201 to read the programs into the RAM 202 as a main storage device from the ROM 203 or the like and execute the programs.

The storage unit 260 is implemented by the ROM 203, the external storage device 204, or the like.

Hardware Configuration of Terminal Apparatus 300

Next, a hardware configuration of the terminal apparatus 300 will be described.

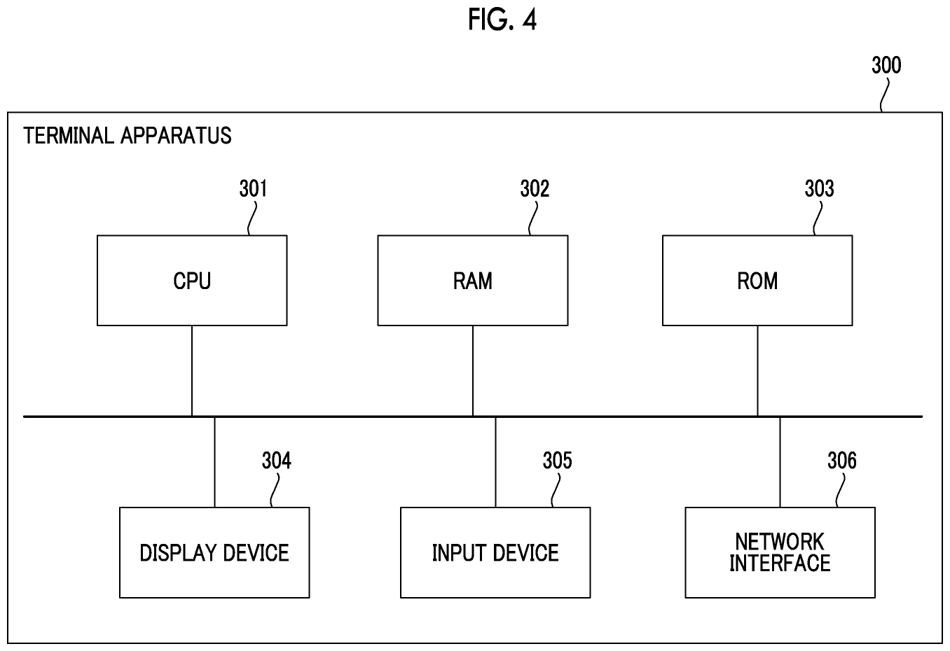

FIG. 4 is a diagram illustrating one example of a hardware configuration of the terminal apparatus 300.

As illustrated in FIG. 4, the terminal apparatus 300 includes a CPU 301, a RAM 302, a ROM 303, a display device 304, an input device 305, and a network interface 306.

The CPU 301 performs various controls and operation processes by executing a program stored in the ROM 303.

The RAM 302 is used as a work memory in the control or the operation process of the CPU 301.

The ROM 303 stores various kinds of data used in the program or the control executed by the CPU 301.

The display device 304 is configured with, for example, a liquid crystal display and displays an image under control of the CPU 301.

The input device 305 is implemented using an input device such as a keyboard, a mouse, or a touch sensor and receives an input operation performed by an operator. In a case where the terminal apparatus 300 is a tablet terminal, a smartphone, or the like, a touch panel in which a liquid crystal display and a touch sensor are combined functions as the display device 304 and the input device 305.

The network interface 306 connects to the network 20 and transmits and receives data with the information processing apparatus 200.

The configuration example illustrated in FIG. 4 is one example of a hardware configuration for implementing the terminal apparatus 300 using a computer. A specific configuration of the terminal apparatus 300 is not limited to the configuration example illustrated in FIG. 4, provided that the functions described below may be implemented.

Functional Configuration of Terminal Apparatus 300

Next, a functional configuration of the terminal apparatus 300 will be described.

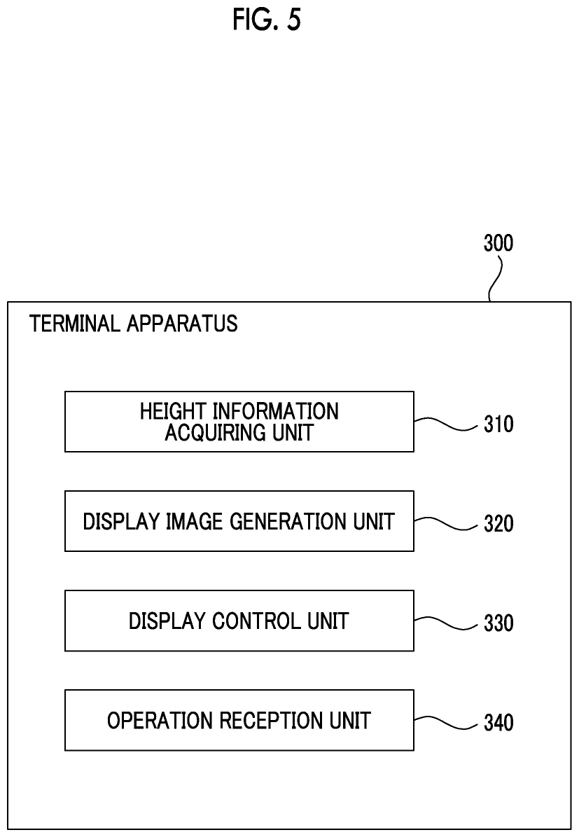

FIG. 5 is a diagram illustrating a functional configuration of the terminal apparatus 300.

As illustrated in FIG. 5, the terminal apparatus 300 includes a height information acquiring unit 310, a display image generation unit 320, a display control unit 330, and an operation reception unit 340.

The height information acquiring unit 310 acquires information related to the height of the person calculated by the information processing apparatus 200 through the network 20. The received information is stored in, for example, the RAM 302 in FIG. 4.

The display image generation unit 320 generates an output image indicating the height of the person based on the information acquired by the height information acquiring unit 310.

The display control unit 330 causes, for example, the display device 304 in the computer illustrated in FIG. 4 to display the output image generated by the display image generation unit 320.

The operation reception unit 340 receives an input operation that is performed by the operator using the input device 305. The display control unit 330 controls display of the output image or the like on the display device 304 in accordance with the operation received by the operation reception unit 340.

The height information acquiring unit 310, the display image generation unit 320, the display control unit 330, and the operation reception unit 340 are implemented by cooperation of software and hardware resources.

Specifically, in the exemplary embodiment, an operating system and application software and the like executed in cooperation with the operating system are stored in the ROM 303 (refer to FIG. 3). In the exemplary embodiment, each of the function units of the height information acquiring unit 310, the display image generation unit 320, the display control unit 330, and the operation reception unit 340 is implemented by causing the CPU 301 to read the programs into the RAM 302 as a main storage device from the ROM 303 or the like and execute the programs.

Method of Calculating Face Pixel Count

Next, a method of calculating the face pixel count will be described.

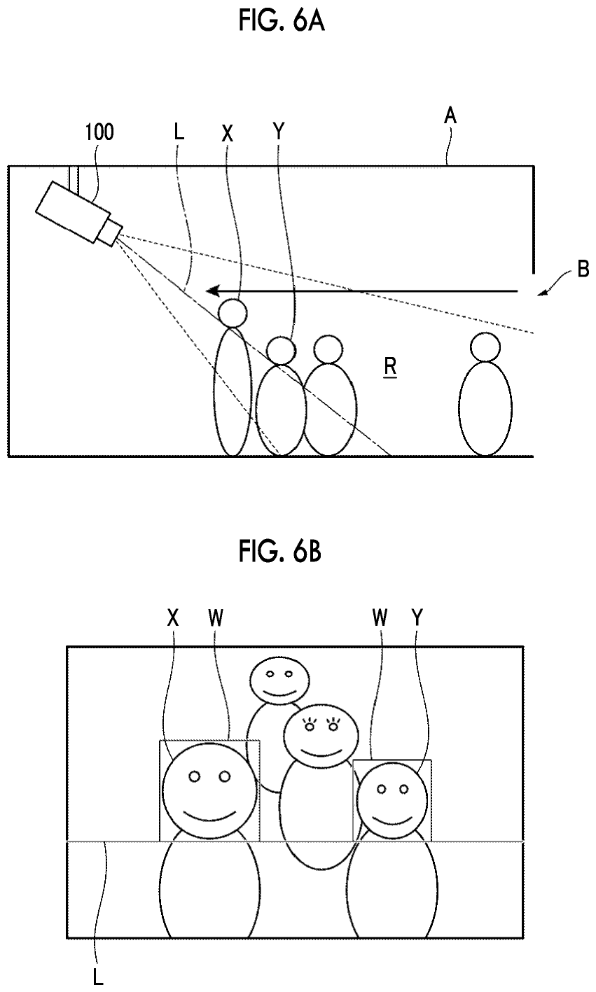

FIG. 6A is a diagram illustrating a state where a person walks within a capturing area of the video camera 100 disposed in a store, and FIG. 6B is a diagram illustrating on example of the motion picture that is acquired from the video camera 100 by the motion picture data acquiring unit 210.

As illustrated in FIG. 6A, in a store A, the video camera 100 is disposed above the person walking in the store A on the deep side of the store A in a case where the store A is seen from an entrance B. The video camera 100 is directed toward the entrance B of the store A. The video camera 100 captures an image displayed in a capturing area R as a motion picture.

As illustrated in FIG. 6B, the person displayed in the capturing area R (refer to FIG. 6A) of the video camera 100 is displayed in the motion picture acquired from the video camera 100 by the motion picture data acquiring unit 210.

The area identification unit 220 identifies a face area W related to the person from the motion picture.

The sensing unit 240 sets a reference line L in a specific area in the motion picture. In the example illustrated in FIG. 6B, the reference line L is a line that horizontally extends in a lateral direction in the motion picture. In the real world space illustrated in FIG. 6A, the reference line L corresponds to a straight line that extends toward the floor of the store A in the capturing area R from a lens of the video camera 100.

The sensing unit 240 senses that the face area W overlaps with the specific area in the motion picture. Specifically, the sensing unit 240 senses that the face area W overlaps with the specific area by sensing that the face area W overlaps with the reference line L in the motion picture. That is, overlapping of the face of the person with the specific area means overlapping of the face area W with the reference line L.

The size calculation unit 250 calculates the pixel count (face pixel count) of the face area W when the sensing unit 240 senses that the face area W overlaps with the reference line L.

The size of the face area W when the face area W related to a person X overlaps with the reference line L, and the size of the face area W when the face area W related to a person Y having a smaller height than the person X overlaps with the reference line L will be described with reference to FIGS. 6A and 6B.

As illustrated in FIG. 6A, in a case where the person X and the person Y walk toward the video camera 100 from the entrance B of the store A, the person X and the person Y overlap with the reference line L. At this point, the person X overlaps with the reference line L at a position closer to the video camera 100 than the person Y.

Thus, as illustrated in FIG. 6B, the size of the face area W when the face area W related to the person X overlaps with the reference line L is larger than the size of the face area W when the face area W related to the person Y overlaps with the reference line L. As the height of the person is increased, the size of the face area W when the face area W overlaps with the reference line L is increased.

Therefore, in the exemplary embodiment, using the fact that the pixel count of the face area W is increased as the size of the face area W is increased, the height of the person is calculated based on the pixel count (face pixel count) of the face area W when the face area W overlaps with the reference line L. That is, in the exemplary embodiment, as the face pixel count is increased, the calculated height is increased.

Description of Face Pixel Count Management Table

Next, information stored in the storage unit 260 will be described.

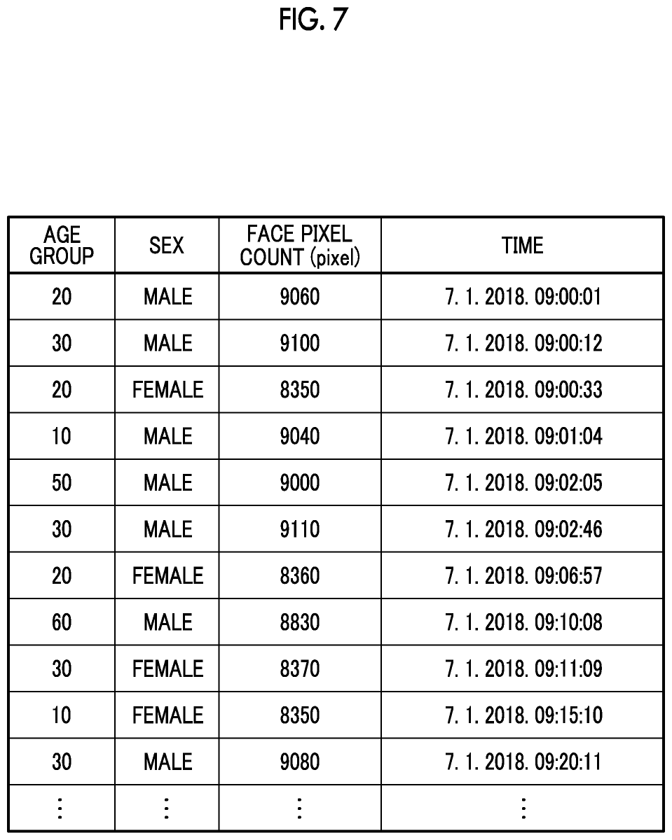

FIG. 7 is a diagram illustrating a configuration example of a face pixel count management table for managing the face pixel count in the storage unit 260.

In the face pixel count management table illustrated in FIG. 7, the age group of the person estimated by the attribute estimation unit 230 is shown in “age group”. The sex of the person estimated by the attribute estimation unit 230 is shown in “sex”. The face pixel count calculated by the size calculation unit 250 is shown in “face pixel count”. The time, date, month, and year at which a record of an image for which the sensing unit 240 senses that the face area overlaps with the reference line L (refer to FIG. 6B) in the motion picture is made is shown in “time”.

In the face pixel count management table of the exemplary embodiment, the “age group” and the “sex” estimated for one person by the attribute estimation unit 230 are associated with the “face pixel count” related to the person.

Description of Method of Creating Height Scale

Next, a method of creating the height scale will be described.

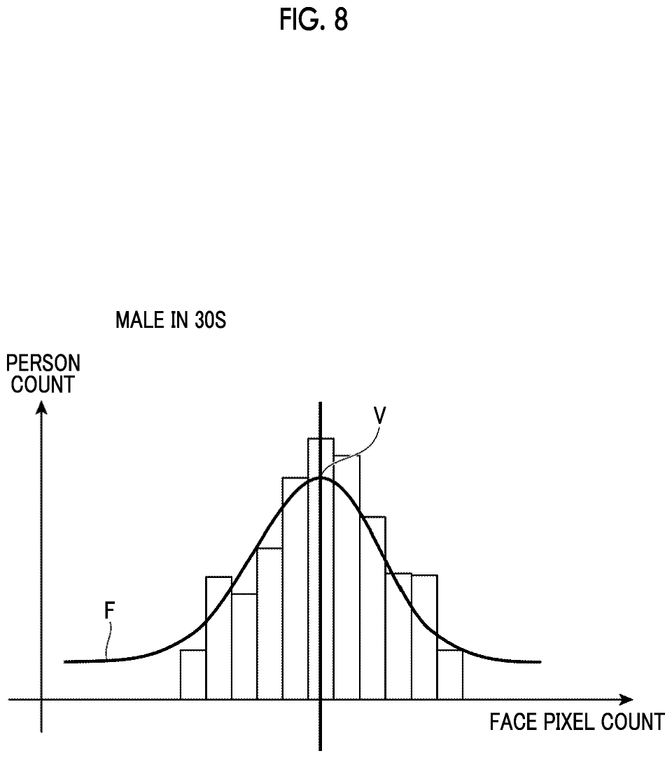

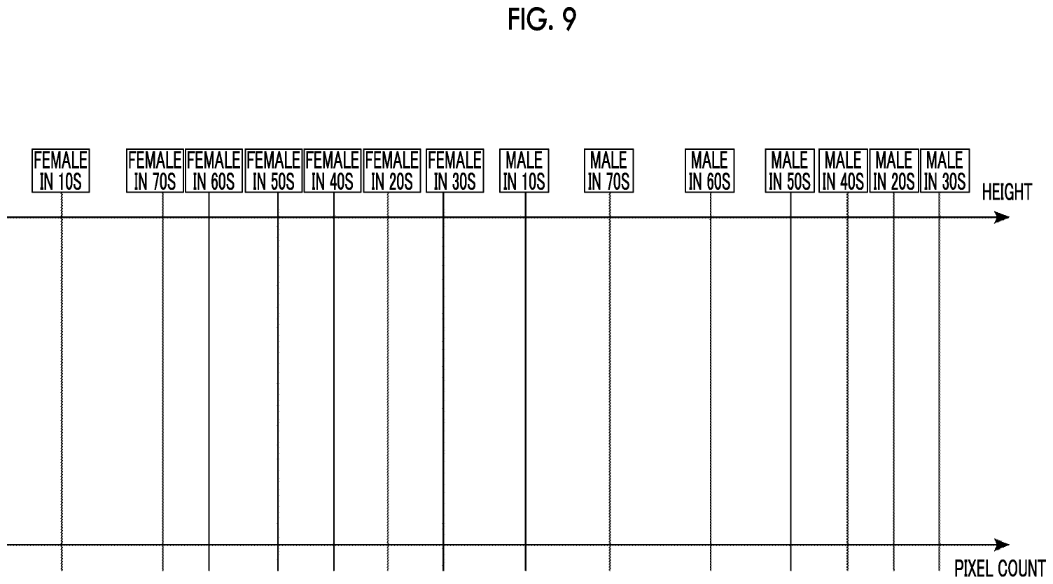

FIG. 8 is a diagram illustrating one example of a histogram created by the scale creating unit 270. FIG. 9 is a diagram illustrating the height scale.

First, the scale creating unit 270 creates a histogram of the face pixel count for each attribute. Specifically, in a case where the number of persons for which the face pixel count associated with one attribute (for example, male in 30s) is stored in the storage unit 260 becomes greater than or equal to a predetermined person count (for example, 30 persons), the scale creating unit 270 creates a histogram of the face pixel count associated with the one attribute using information related to the face pixel counts of the persons.

The histogram illustrated in FIG. 8 is a histogram of the face pixel count for male in 30s. This histogram is created based on information related to the “face pixel count” associated with “in 30s” and “male” in the face pixel count management table stored in the storage unit 260. In the histogram, a lateral axis denotes the face pixel count, and a vertical axis denotes the number of persons (person count) related to the face pixel count.

Next, the scale creating unit 270 determines the pixel count to be associated with the predetermined height. Specifically, the scale creating unit 270 creates a normal distribution F by fitting the created histogram and associates the predetermined height with the face pixel count at a peak V of the created normal distribution F. The face pixel count at the peak V of the normal distribution is the average value of the face pixel counts in the normal distribution F. The predetermined height is exemplified by, for example, the average value of heights for each attribute. For example, the average value of known heights may be used as the average value of heights. In addition, for example, the average value of heights that is acquired as a result of measuring the heights of two or more persons may be used as the average value of heights.

The scale creating unit 270 is regarded as a determination section that determines a size to be associated with a predetermined height based on a face pixel count. In addition, the scale creating unit 270 is regarded as a creating section that creates a normal distribution of the face pixel count for each attribute.

The scale creating unit 270 creates the histogram and determines the pixel count to be associated with the predetermined height for the remaining attributes. By causing the scale creating unit 270 to create the histogram and determine the pixel count to be associated with the predetermined height for each attribute, a height scale in which the predetermined height is associated with the pixel count for each attribute is created as illustrated in FIG. 9.

Description of Method of Calculating Height

Next, a method of calculating the height will be described.

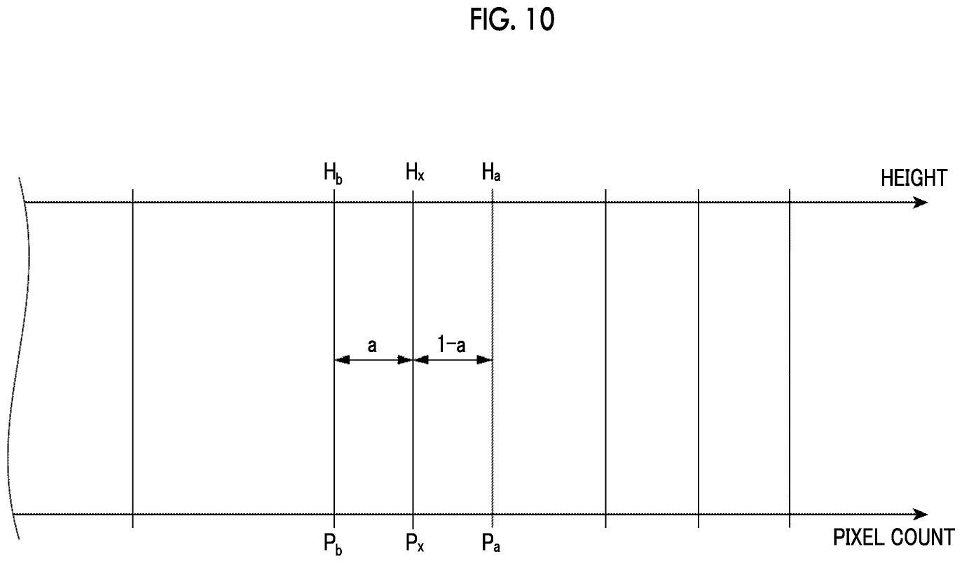

FIG. 10 is a diagram illustrating a method of calculating the height by the height calculation unit 280.

Hereinafter, a method of calculating the height from the face pixel count calculated by the size calculation unit 250 will be described with reference to FIG. 10.

In calculation of the height from a target face pixel count Pₓ, first, the height calculation unit 280 determines whether or not the pixel count associated with any attribute is used as a reference among the pixel counts shown in the height scale. Specifically, the height calculation unit 280 determines that the next larger pixel count than the target face pixel count Pₓ and the next smaller face pixel count than the target face pixel count Pₓ are used as references among the pixel counts shown in the scale for each attribute. In a case where a pixel count that is larger than the target face pixel count Pₓ is not shown in the scale, the next smaller pixel count and the second next smaller pixel count than the target face pixel count Pₓ are used as references among the pixel counts shown in the scale for each attribute. In a case where a pixel count that is smaller than the target face pixel count Pₓ is not shown in the scale, the next larger pixel count and the second next larger pixel count than the target face pixel count Pₓ are used as references among the pixel counts shown in the scale for each attribute.

Next, the height calculation unit 280 calculates a height H using Expression (1).

H=a×Hₐ+(1−a)×H_{b} Expression (1)

In Expression (1), Hₐ denotes a height associated with the larger pixel count of two pixel counts used as references in calculation of the height, and H_{b} denotes a height associated with the smaller pixel count. Expression (2) is used for obtaining a.

a=Pₓ−P_{b}/Pₐ−P_{b} Expression (2)

In Expression (2), Pₐ denotes the larger pixel count of the two pixel counts used as references in calculation of the height, and P_{b} denotes the smaller pixel count.

The height calculation unit 280 calculates a by substituting the target face pixel count Pₓ in Expression (2). In addition, the height H is calculated by substituting calculated a in Expression (1).

Flow of Process of Calculating Height

Next, a flow of process of calculating the height (height calculation process) will be described.

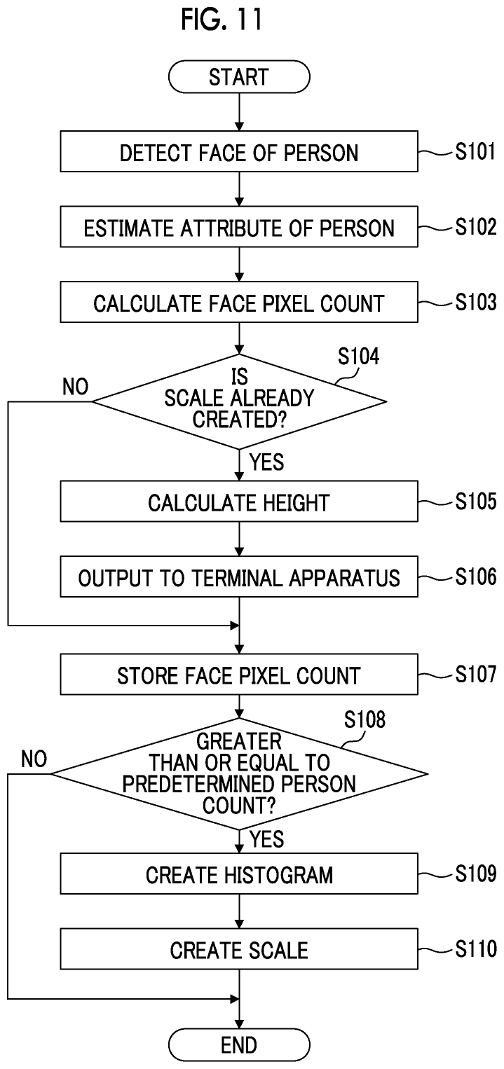

FIG. 11 is a flowchart illustrating the flow of height calculation process. The height calculation process is a process that is performed in a case where the motion picture data acquiring unit 210 acquires new motion picture data from the video camera 100.

First, the area identification unit 220 detects the face of the person displayed in the motion picture acquired by the motion picture data acquiring unit 210 (S101) and identifies the face area related to the person.

The attribute estimation unit 230 estimates the attribute of the person from the face of the person detected by the area identification unit 220 (S102).

The size calculation unit 250 calculates the face pixel count related to the person of which the face is detected by the area identification unit 220 (S103).

Next, the height calculation unit 280 determines whether or not the height scale (refer to FIG. 9) is already created by the scale creating unit 270 (S104). In this case, the height calculation unit 280 determines that the height scale is already created in a case where there are two or more attributes for which the height and the pixel count are associated in the height scale. In a case where there are less than two of such attributes, the height calculation unit 280 determines that the height scale is not created yet.

In a case where it is determined that the height scale is already created (YES in S104), the height calculation unit 280 calculates the height of the person from the face pixel count calculated by the size calculation unit 250 (S105). Specifically, the height calculation unit 280 calculates the height based on the face pixel count calculated by the size calculation unit 250 and the height and the pixel count shown in the height scale.

The output unit 290 outputs information related to the calculated height to the terminal apparatus 300 (S106).

After step S106 or in a case where a negative result is acquired in step S104, the storage unit 260 stores the face pixel count calculated by the size calculation unit 250 in association with the attribute estimated by the attribute estimation unit 230 (S107). The stored information is managed as the face pixel count management table (refer to FIG. 7).

Next, with reference to the face pixel count management table, the scale creating unit 270 determines whether or not the person count for which the face pixel count associated with the attribute estimated in step S103 is stored in the storage unit 260 is greater than or equal to a predetermined person count (S108). In a case where a negative result is acquired, the height calculation process is finished.

In a case where a positive result is acquired in step S108, the scale creating unit 270 creates a histogram of the face pixel count for the attribute estimated in step S103 (S109).

Next, the scale creating unit 270 creates a normal distribution for the histogram and creates a height scale in which the average value of face pixel counts in the created normal distribution is associated with the predetermined height (S110).

In a case where a positive result is acquired in step S108, the process from step S109 may be performed even in a case where the height is associated with the pixel count in the height scale for the attribute estimated in step S103. That is, the pixel count associated with the predetermined height in the height scale may be updated. In this case, a new histogram that includes a new face pixel count calculated by the size calculation unit 250 is created, and the pixel count to be associated with the predetermined height in the height scale is determined based on the histogram.

In a case where the faces of plural persons are displayed in the motion picture, the height calculation process is performed for each of the plural persons.

In the exemplary embodiment, the height of the person displayed in the image is calculated based on the size of the face when the face of the person displayed in the image captured by the video camera 100 overlaps with the specific area present in the image.

For example, the height of the person having a human body displayed in the image may be calculated from the distance between a head and a foot of the human body displayed in the captured image. However, depending on cases, both of the head and the foot of the human body may not be displayed in the captured image. In this case, the height of the person displayed in the image may not be easily calculated.

Meanwhile, as in the exemplary embodiment, in a case where the height of the person is calculated based on the size of the face of the person displayed in the image, the height of a person of which the face is displayed but the foot is not displayed in the image is calculated.

In the exemplary embodiment, while the height is calculated from the size of the face of the person, the present invention is not limited thereto.

For example, the height may be calculated from the size of a hand of the person displayed in the image. In this case, the area identification unit 220 detects the hand of the person displayed in the image and identifies an area in which the hand is displayed. The attribute estimation unit 230 extracts features such as parts, contours, and wrinkles on the identified hand of the person and estimates the attribute of the person having the hand based on the extracted features. The size calculation unit 250 calculates the pixel count constituting the image in the area of the hand when the area of the hand of the person overlaps with the reference line L (refer to FIG. 6B) in the image. The calculated pixel count is accumulated in the storage unit 260 in association with the estimated attribute. The scale creating unit 270 creates a histogram of the pixel count of the area of the hand accumulated in the storage unit 260 for each attribute, determines the pixel count to be associated with the predetermined height for each attribute based on the created histogram, and creates a height scale. The height calculation unit 280 calculates the height based on a relationship between the pixel count of the area of the hand when the area of the hand of the person overlaps with the reference line L in the image, and the pixel count shown in the scale.

The part of the human body that is used in calculation of the height of the person may be a part of the human body other than the face or the hand.

That is, one specific part of the human body displayed in the image may be detected by the area identification unit 220, and the height of the person having the human body displayed in the image may be calculated based on the size of the one part when the detected one part overlaps with the specific area present in the image.

In the exemplary embodiment, the scale creating unit 270 determines the pixel count to be associated with the predetermined height based on the face pixel count calculated by the size calculation unit 250. The height calculation unit 280 calculates the height of the person based on the relationship between the face pixel count calculated by the size calculation unit 250 and the pixel count associated with the predetermined height.

Thus, depending on the type of video camera 100 or the position at which the video camera 100 is disposed, the face pixel count calculated by the size calculation unit 250 changes, and accordingly, the size associated with the predetermined height also changes.

Content Output to Display Device 304

Next, a content that is output to the display device 304 of the terminal apparatus 300 will be described.

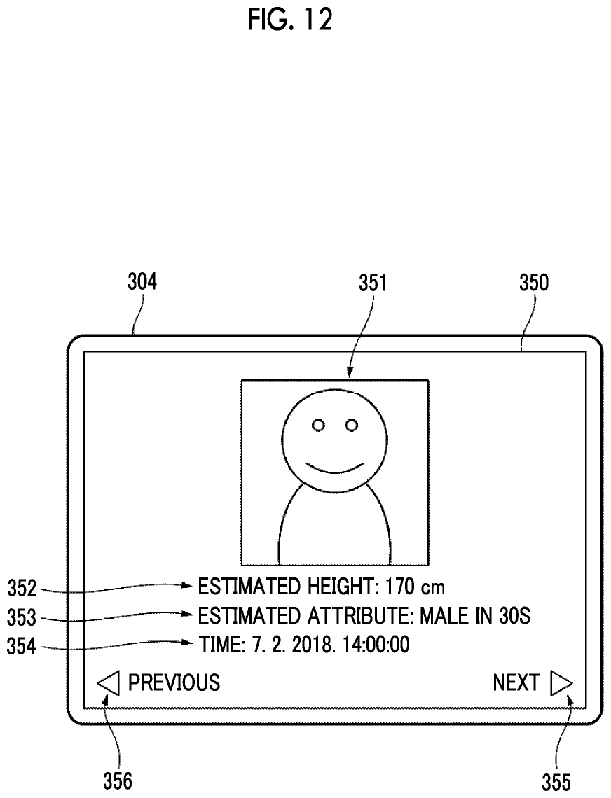

FIG. 12 is a diagram illustrating a calculation result image 350 that is an image related to the result of calculation of the height by the height calculation unit 280.

As illustrated in FIG. 12, a person image 351, height information 352, attribute information 353, time information 354, a next button 355, and a previous button 356 are displayed in the calculation result image 350.

The image of the person of which the height is calculated is displayed in the person image 351. Specifically, the image that is identified as the face area by the area identification unit 220 for the person of which the height is calculated is displayed in the person image 351.

The height calculated by the height calculation unit 280 is displayed in the height information 352.

The attribute estimated by the attribute estimation unit 230 for the person of which the height is calculated is displayed in the attribute information 353. Specifically, the age group and the sex of the person estimated by the attribute estimation unit 230 are displayed in the attribute information 353.

The time when the person of which the height is calculated is captured by the video camera 100 is displayed in the time information 354. Specifically, the time, date, month, and year at which a record of an image for which the sensing unit 240 senses that the face area related to the person of which the height is calculated overlaps with the reference line L (refer to FIG. 6B) in the motion picture is made are displayed in the time information 354. In the example illustrated in FIG. 12, “2018. 7. 2. 14:00:00” is displayed as the time information 354.

In a case where the operator selects the next button 355, the calculation result image 350 related to a person who is sensed by the sensing unit 240 at the next later time than the time displayed in the time information 354 is displayed. In a case where the operator selects the previous button 356, the calculation result image 350 related to a person who is sensed by the sensing unit 240 at the next earlier time than the time displayed in the time information 354 is displayed.

In the exemplary embodiment, while the video camera 100 is disposed above the walking person (refer to FIG. 6A), the present invention is not limited thereto.

The video camera 100 may be disposed below the face of the walking person, for example, at the height of the foot of the walking person. That is, the video camera 100 may be disposed such that a difference in level is present with respect to the one specific part used in calculation of the height of the walking person.

In the exemplary embodiment, one reference line L (refer to FIG. 6B) is set in the specific area in the motion picture, and the pixel count of the face area when the face area overlaps with the reference line L is calculated. Based on the calculated pixel count, the pixel count to be associated with the predetermined height is determined. However, the present invention is not limited thereto.

For example, two or more reference lines may be set in the motion picture, and the pixel count to be associated with the predetermined height may be determined based on the average value of pixel counts of the face area when the face area overlaps with each reference line.

In the exemplary embodiment, while the pixel count to be associated with the predetermined height is determined based on the pixel count constituting the face area identified by the area identification unit 220, the present invention is not limited thereto.

For example, background subtraction may be performed on the image of the face area identified by the area identification unit 220 using an image that is captured in a state where no person is displayed in the capturing area of the video camera 100. The pixel count to be associated with the predetermined height may be determined based on the pixel count constituting the image acquired as a difference.

In the exemplary embodiment, while the pixel count to be associated with the predetermined height is determined based on the pixel count of the face area in the image when the face area overlaps with the reference line L, the present invention is not limited thereto.

For example, the pixel count to be associated with the predetermined height may be determined based on the average value of pixel counts of the face area in each image constituting the motion picture while the face area overlaps with the reference line L.

In addition, for example, the pixel count to be associated with the predetermined height may be determined based on the average value of pixel counts of the face area in each image constituting the motion picture in one cycle of the walking of the person during which the face area overlaps with the reference line L.

Specifically, the area identification unit 220 detects the regularity of oscillation of the face area in the up-down direction of the motion picture and detects the cycle of the walking of the person from the regularity of oscillation. Each image constituting the motion picture in the period of one cycle of the walking in a period during which the face area overlaps with the reference line L in the motion picture may be extracted. The pixel count to be associated with the predetermined height may be determined based on the average value of pixel counts of the face area in the extracted images.

In the exemplary embodiment, while the pixel count to be associated with the predetermined height in the height scale is the face pixel count at the peak V of the normal distribution F (refer to FIG. 8) created for the histogram, the present invention is not limited thereto.

For example, the average value of face pixel counts for each attribute stored in the storage unit 260 may be associated with the predetermined height in the height scale.

In addition, for example, the pixel count associated with the predetermined height may be corrected based on the face pixel count related to a person having a known height. Specifically, the face pixel count related to the person is calculated from a motion picture that is acquired by capturing the person having a specific attribute with a known height using the video camera 100. The height and the pixel count that are associated with each other in the height scale for the specific attribute may be replaced with the height of the person having a known height and the face pixel count calculated for the person.

In addition, for example, each pixel count associated with the height may be corrected for each attribute based on the pixel count of the face area when the face area of the person having a known height overlaps with the reference line L.

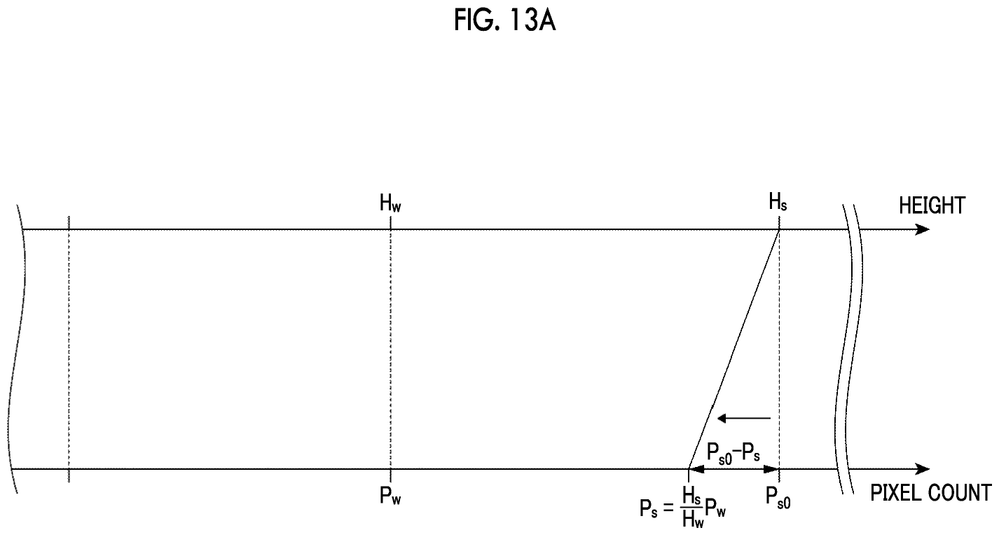

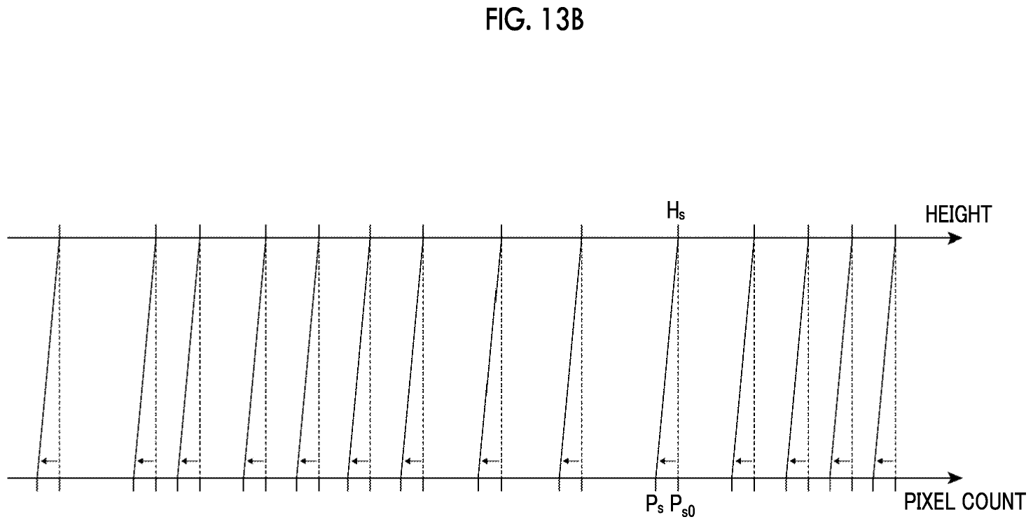

FIGS. 13A and 13B are diagrams illustrating a method of correcting each pixel count associated with the height for each attribute.

Hereinafter, a method of correcting each pixel count associated with the height for each attribute will be described with reference to FIGS. 13A and 13B.

First, a pixel count Pₛ₀ (refer to FIG. 13A) that is shown in the height scale for the attribute of the person having a known height is corrected. Specifically, the pixel count (pixel count before correction) Pₛ₀ that is shown in the height scale for the attribute of the person having a known height is set to a pixel count Pₛ after correction using Expression (3).

$${P}_{s} = \frac{{H}_{s}}{{H}_{w}} {P}_{w} \qquad Expression ( 3 )$$

In Expression (3), H_{w} denotes the height of the person having a known height, and P_{w} denotes the face pixel count calculated for the person. In addition, Hₛ denotes the height shown in the height scale for the attribute of the person having a known height.

Next, the pixel counts shown in the height scale for the remaining attributes are corrected. Specifically, the value of change in pixel count for the initially corrected attribute is subtracted from each pixel count shown in the height scale for the remaining attributes. More specifically, each pixel count associated in the height scale for the remaining attributes is corrected by subtracting, from each pixel count shown in the height scale for the remaining attributes, a value (Pₛ₀−Pₛ) acquired by subtracting the pixel count Pₛ after correction from the pixel count Pₛ₀ before correction for the initially corrected attribute.

In the exemplary embodiment, while the height and the pixel count are associated with each other for each age group and each sex in the height scale, the attribute that is used as a category for associating the height with the pixel count in the height scale is not limited to age group and sex.

For example, the height and the pixel count may be shown in the height scale for each nationality. In this case, the attribute estimation unit 230 estimates the age group, the sex, and the nationality of the person from the features of the face identified by the area identification unit 220. The scale creating unit 270 may create a height scale in which the height determined for each age group, each sex, and each nationality is associated with the pixel count, by determining the pixel count of the person to be associated with the height determined for each age group, each sex, and each nationality.

In the exemplary embodiment, in a case where the person count for which the face pixel count associated with one attribute is stored in the storage unit 260 becomes greater than or equal to the predetermined person count, a histogram of the face pixel count associated with the one attribute is created. However, the present invention is not limited thereto.

For example, a determination as to whether or not to create a histogram may be made based on periods. Specifically, a timing unit (not illustrated) that measures time may be disposed in the information processing apparatus 200. In a case where a predetermined period (for example, 30 days) elapses from when the motion picture data acquiring unit 210 acquires the motion picture data for the first time, a histogram may be created using information related to the face pixel count stored in the storage unit 260.

In the exemplary embodiment, a motion picture is captured using the video camera 100, and the height of the person displayed in the captured motion picture data is calculated. However, the present invention is not limited thereto.

For example, a photograph may be captured using a capturing means that captures an image, and the height of the person may be calculated based on the size of the face area of the person in the captured photograph.

A program that implements the exemplary embodiment of the present invention may be provided in a state where the program is stored in a computer readable recording medium such as a magnetic recording medium (a magnetic tape, a magnetic disk, or the like), an optical storage medium (optical disc or the like), a magneto-optical recording medium, or a semiconductor memory. In addition, the program may be provided using a communication means such as the Internet.

The present disclosure is not limited to the exemplary embodiment and may be embodied in various forms without departing from the nature of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A height calculation system comprising:
a capturing section that captures an image;
a detection section that detects a specific body part of a human in the image captured by the capturing section; and
a calculation section that calculates a height of the human based on a size of the part when the part detected by the detection section overlaps with a specific area present in the image.

2. The height calculation system according to claim 1, further comprising:
an acquiring section that acquires part information related to the size of the part when the specific body part detected by the detection section overlaps with the specific area; and
a determination section that determines a size to be associated with a predetermined height based on the part information acquired by the acquiring section,
wherein the calculation section calculates the height of the person based on a relationship between the size of the part when the one part overlaps with the specific area and the size associated with the predetermined height.

3. The height calculation system according to claim 2, further comprising:
an estimation section that estimates an attribute of the person related to the part information,
wherein the determination section determines each size to be associated with a height determined for each attribute, and
the calculation section calculates the height of the person based on a relationship between the size of the part when the one part overlaps with the specific area and a size that is the closest to the size of the one part among the sizes associated with the height for each attribute.

4. The height calculation system according to claim 3, further comprising:
a creating section that creates a normal distribution of the size of the part for each attribute based on the part information,
wherein the determination section associates the predetermined height with an average value in the normal distribution for each attribute.

5. The height calculation system according to claim 3,
wherein the attribute is an age group and/or a sex of the person, and
the height determined for each attribute is a height that is determined as an average value of heights for each attribute.

6. The height calculation system according to claim 4,
wherein the attribute is the age group and/or the sex of the person, and
the height determined for each attribute is a height that is determined as an average value of heights for each attribute.

7. The height calculation system according to claim 2,
wherein the image is one image in the captured motion picture, and
the part information is information related to an average value of the sizes of the parts in each image constituting the motion picture while the detected one part overlaps with the specific area.

8. The height calculation system according to claim 7,
wherein the average value is an average value of the sizes of the parts in each image constituting the motion picture in one cycle of walking of the person related to the part during which the detected one part overlaps with the specific area.

9. The height calculation system according to claim 3,
wherein the determination section corrects each value of the size associated with the height for each attribute based on the size of a part when a specific body part of a human of a person of which the height is known overlaps with the specific area.

10. The height calculation system according to claim 4,
wherein the determination section corrects each value of the size associated with the height for each attribute based on the size of a part when a specific body part of a human of a person of which the height is known overlaps with the specific area.

11. The height calculation system according to claim 5,
wherein the determination section corrects each value of the size associated with the height for each attribute based on the size of a part when a specific body part of a human of a person of which the height is known overlaps with the specific area.

12. The height calculation system according to claim 6,
wherein the determination section corrects each value of the size associated with the height for each attribute based on the size of a part when a specific body part of a human of a person of which the height is known overlaps with the specific area.

13. The height calculation system according to claim 7,
wherein the determination section corrects each value of the size associated with the height for each attribute based on the size of a part when a specific body part of a human of a person of which the height is known overlaps with the specific area.

14. The height calculation system according to claim 8,
wherein the determination section corrects each value of the size associated with the height for each attribute based on the size of a part when a specific body part of a human of a person of which the height is known overlaps with the specific area.

15. The height calculation system according to claim 1,
wherein the calculation section calculates the height of the person based on a relationship among the size of the part when the one part overlaps with the specific area, a first size that is associated with a first height and is smaller than the size of the part, and a second size that is larger than the size of the part and is associated with a second height which is larger than the first height.

16. The height calculation system according to claim 9,
wherein the determination section determines each size to be associated with three or more predetermined heights by increasing the size to be associated as the height is increased, and
in calculation of the height of the person, the calculation section uses a next smaller size than the size of the one part and a next larger size than the size of the one part among the three or more sizes determined by the determination section.

17. The height calculation system according to claim 10,
wherein the determination section determines each size to be associated with three or more predetermined heights by increasing the size to be associated as the height is increased, and
in calculation of the height of the person, the calculation section uses a next smaller size than the size of the one part and a next larger size than the size of the one part among the three or more sizes determined by the determination section.

18. The height calculation system according to claim 11,
wherein the determination section determines each size to be associated with three or more predetermined heights by increasing the size to be associated as the height is increased, and
in calculation of the height of the person, the calculation section uses a next smaller size than the size of the one part and a next larger size than the size of the one part among the three or more sizes determined by the determination section.

19. An information processing apparatus comprising:
a detection section that detects a specific body part of a human in a captured image; and
a calculation section that calculates a height of a human based on a size of a part when the one part detected by the detection section overlaps with a specific area present in the image.

20. A non-transitory computer readable medium storing a program causing a computer to implement:
a function of detecting a specific body part of a human of a person displayed in a captured image; and
a function of calculating a height of the person based on a size of a part when the detected one part overlaps with a specific area present in the image.
